(19) United States
(12) Patent Application Publication
(10) Pub. No.: US 2003/0072320 A1
(43) Pub. Date: Apr. 17, 2003

(54) Direct conversion receiver capable of supporting multiple standard specifications in a mobile communication system

(75) Inventors: Hae-Moon Seo, Yongin-shi (KR); Young-Kon Lee, Yongin-shi (KR); Hyoung-Kil Lim, Songnam-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/237,418

(22) Filed: Sep. 9, 2002

(30) Foreign Application Priority Data
Oct. 13, 2001 (KR) 2001/63232

(51) Int. Cl. H04B 7/216

(52) U.S. Cl. 370/441; 370/342

(57) ABSTRACT

Disclosed is a direct conversion receiver capable of supporting multiple standard specifications in mobile communication systems. A mode switch selects a received signal having a specific standard specification from received signals according to a mode selection signal. A low-noise amplifier is turned on in response to the mode selection signal, and low-noise amplifies the signal selected by the mode switch. A frequency down-converter frequency down-converts the low-noise amplified signal to a frequency corresponding to the specific standard specification. A high-pass filter bank high-pass filters the frequency down-converted signal. A programmable analog-to-digital converter converts the high-pass filtered signal into a sampling frequency corresponding to the specific standard specification. A digital filter digital-filters the converted digital signal using a decimation rate and a filter bandwidth corresponding to the specific standard specification. A digital signal processor generates the mode selection signal, and a control signal for generating the sampling frequency.

### PRIORITY

This application claims priority to an application entitled “Direct Conversion Receiver Capable of Supporting Multiple Standard Specifications in a Mobile Communication System” filed in the Korean Industrial Property Office on Oct. 13, 2001 and assigned Serial No. 2001-63232, the contents of which are hereby incorporated by reference.

### BACKGROUND OF THE INVENTION

1. Field of the Invention

The present invention relates generally to a receiver for mobile communication systems, and in particular, to a direct conversion receiver capable of supporting multiple standard specifications.

2. Description of the Related Art

With a rapid development of mobile communication systems, there have been proposed various standard specifications for the various mobile communication systems. All the countries of the world adopt an appropriate standard specification selected based on their radio environments and development phases. At present, an IMT-2000 mobile communication system, a 3^{rd} generation mobile communication system, has evolved into WCDMA (Wideband Code Division Multiple Access) standard specification led by Europe and Japan, CDMA2000 standard specification led by the United States, and TD-SCDMA (Time Division-Synchronous Code Division Multiple Access) standard specification led by China.

As all the countries of the world employ an appropriate standard specification selected based on the circumstances they face, separate receivers capable of supporting the respective standard specifications have been developed. However, it is inefficient to develop separate receivers supporting the different individual standard specifications. Accordingly, there is an increasing demand for a receiver capable of supporting all of the standard specifications for the IMT-2000 system.

FIG. 1 illustrates a structure of a conventional direct conversion receiver (DCR). Referring to FIG. 1, an RF (Radio Frequency) signal received over the air through an antenna 111 is applied to a duplexer 113. The duplexer 113 duplexes the RF signal received from the antenna 111, and provides the duplexed signal to a low-noise amplifier (LNA) 115. The low-noise amplifier 115 low-noise amplifies the duplexed signal output from the duplexer 113, and provides its output signal in common to a first mixer 121 and a second mixer 141.

The first mixer 121 multiplies the signal output from the low-noise amplifier 115 by a synthetic frequency output from a frequency synthesizer 155, and provides its output signal to a first adder 123. The frequency synthesizer 155 frequency-synthesizes an output signal of a digital signal processor (DSP) 133 with a frequency signal generated by a crystal oscillator 157, to generate the synthetic frequency. The first adder 123 adds the output signal of the first mixer 121 to an output signal of a first digital-to-analog converter (DAC) 135, and provides its output signal to a first low-pass filter (LPF) 125. Here, the first digital-to-analog converter 135 converts a digital signal output from the digital signal processor 133 into an analog signal, and outputs a DC offset-canceled in-phase (I) component signal.

The first low-pass filter (LPF) 125 low-pass filters the output signal of the first adder 123, and provides the low-pass filtered signal to a first automatic gain controller (AGC) 127. The first automatic gain controller 127 automatic-gain controls the low-pass filtered signal output from the first low-pass filter 125, and provides its output signal to a first anti-aliasing filter 129. The first anti-aliasing filter 129 removes an aliasing component from the output signal of the first automatic gain controller 127, and provides its output signal to a first analog-to-digital converter (ADC) 131. The first analog-to-digital converter 131 converts an analog signal output from the first anti-aliasing filter 129 to a digital signal, and provides the digital signal to the digital signal processor 133. The digital signal processor 133 performs digital signal processing on the digital signal output from the first analog-to-digital converter 131, and provides its output signal to the frequency synthesizer 155, the first digital-to-analog converter 135 and a second digital-to-analog converter 153.

Second mixer 141 multiplies the signal output from the low-noise amplifier 115 by a signal obtained by phase shifting the synthetic frequency output from the frequency synthesizer 155 by 90°, and provides its output signal to a second adder 143. Phase shifting the output signal of the frequency synthesizer 155 by 90° in the second mixer 141 is to detect a quadrature-phase (Q) component signal having a 90°-phase difference with the I component signal. The second adder 143 adds the output signal of the second mixer 141 to an output signal of the second digital-to-analog converter (DAC) 153, and provides its output signal to a second low-pass filter (LPF) 145. The second digital-to-analog converter 153 converts a digital signal output from the digital signal processor 133 into an analog signal, and outputs a DC offset-canceled quadrature-phase (Q) component signal.

The second low-pass filter (LPF) 145 low-pass filters the output signal of the second adder 143, and provides the low-pass filtered signal to a second automatic gain controller (AGC) 147. The second automatic gain controller 147 automatic-gain controls the low-pass filtered signal output from the second lowpass filter 145, and provides its output signal to a second anti-aliasing filter 149. The second anti-aliasing filter 149 removes an aliasing component from the output signal of the second automatic gain controller 147, and provides its output signal to a second analog-to-digital converter (ADC) 151. The second analog-to-digital converter 151 converts an analog signal output from the second anti-aliasing filter 149 to a digital signal, and provides the digital signal to the digital signal processor 133. The digital signal processor 133 performs digital signal processing on the digital signal output from the second analog-to-digital converter 151, and provides its output signal to the frequency synthesizer 155, the first digital-to-analog converter 135 and the second digital-to-analog converter 153.

It is not possible for the direct conversion receiver of FIG. 1 to support all of the currently available standard specifications for the IMT-2000 system. Further, since the direct conversion receiver is constructed to use the analog-to-digital converters, it requires many devices such as the low-pass filters, the automatic gain controllers and the digital-to-analog converters at its base band stage. In addition, it is difficult to design a feedback loop for canceling a DC offset from the received signal. This is why separate receivers supporting the individual standard specifications have been used. As mentioned above, however, it is inefficient to develop separate receivers supporting the individual standard specifications, resulting in a waste of resources. Accordingly, there is an increasing demand for a receiver capable of supporting all of the standard specifications for the IMT-2000 system.

### SUMMARY OF THE INVENTION

It is, therefore, an object of the present invention to provide a receiver capable of supporting multiple standard specifications in a mobile communication system.

It is another object of the present invention to provide a receiver with a simple hardware structure in a mobile communication system.

To achieve the above and other objects, there is provided a direct conversion receiver capable of supporting multiple standard specifications in a mobile communication system. The direct conversion receiver comprises a mode switch for selecting a received signal having a specific standard specification from received signals according to a mode selection signal. A low-noise amplifier is turned on in response to the mode selection signal, for low-noise amplifying the received signal selected by the mode switch. A frequency down-converter frequency down-converts the low-noise amplified signal into a frequency corresponding to the specific standard specification. A high-pass filter bank high-pass filters the frequency down-converted signal. A programmable analog-to-digital converter converts the high-pass filtered signal into a sampling frequency corresponding to the specific standard specification. A digital filter digital-filters the converted digital signal using a decimation rate and a filter bandwidth corresponding to the specific standard specification. A digital signal processor generates the mode selection signal for selecting a desired standard specification signal from the received signals, and generates a control signal for generating the sampling frequency.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a structure of a conventional direct conversion receiver DCR);

FIG. 2 illustrates a structure of a receiver capable of supporting multiple standard specifications according to an embodiment of the present invention;

FIG. 3 illustrates an internal structure of the digital filters shown in FIG. 2; and

FIG. 4 illustrates relationships between a signal-to-noise ratio and a high-pass filter bank of FIG. 3.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

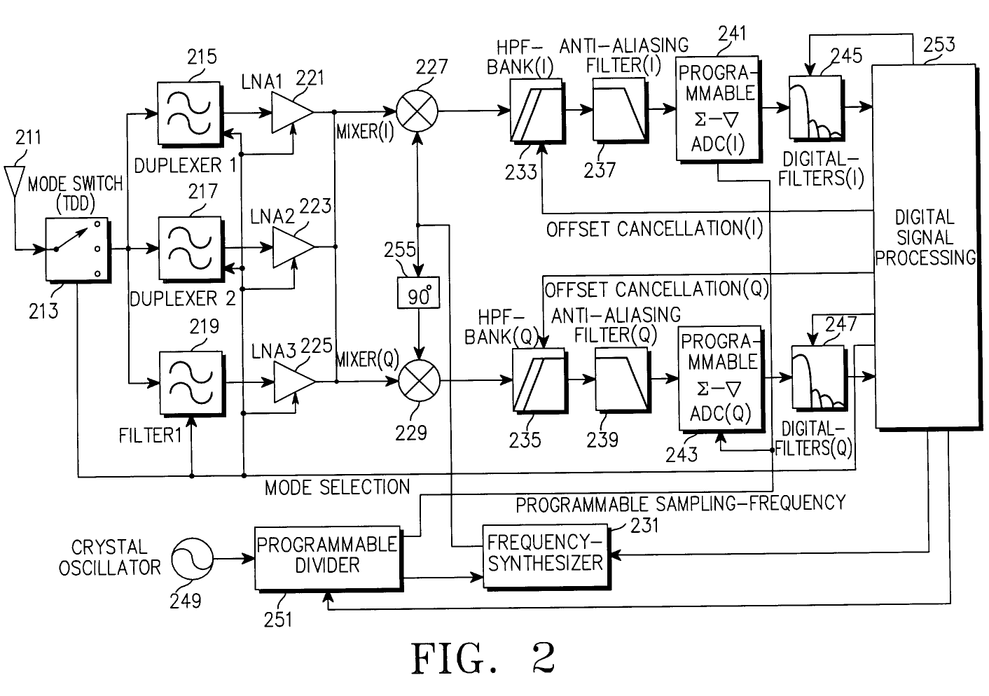

FIG. 2 illustrates a structure of a receiver capable of supporting multiple standard specifications according to an embodiment of the present invention. The receiver of FIG. 2 has a structure capable of supporting all of the standard specifications for the IMT-2000 mobile communication system, including the WCDMA standard specification led by Europe and Japan, the CDMA2000 standard specification led by the United States, and the TD-SCDMA standard specification led by China. The receiver can be employed in a user element (UE), such as a mobile phone, and a radio access network (RAN).

Fundamentally, the receiver of FIG. 2 has a direct conversion receiver (DCR) structure, and is comprised of an RF (Radio Frequency) front-end part, a frequency down-conversion part, and a base band part. The RF front-end part includes a mode switch 213, a first duplexer 215, a second duplexer 217, a filter 219, a first low-noise amplifier (LNA) 221, a second low-noise amplifier 223, and a third low-noise amplifier 225, in order to separately process multiple standard specification signals.

The frequency down-conversion part includes a first mixer 227, a second mixer 229, and a frequency synthesizer 231. Further, the base band part includes a first high-pass filter bank (HPF-bank) 233, a second high-pass filter bank 235, a first anti-aliasing filter 237, a second anti-aliasing filter 239, a first programmable Σ-∇ analog-to-digital converter (ADC) 241, a second programmable Σ-∇ analog-to-digital converter 243, a first digital filter 245, a second digital filter 247, a crystal oscillator 249, a programmable divider 251, and a digital signal processor 253.

Referring to FIG. 2, an RF signal received over the air through an antenna 211 is applied to the mode switch 213. Here, the RF signal received through the antenna 211 is a mixture of multiple standard specification signals, including WCDMA signal, CDMA2000 signal and TD-SCDMA signal. The digital signal processor 253 generates a control signal, i.e., a mode selection signal, and provides the generated mode selection signal to the mode switch 213, the first duplexer 215, the second duplexer 217 and the filter 219. The mode selection signal generated by the digital signal processor 253 is used in selecting a specific standard specification signal from the multiple standard specification signals received through the antenna 211. For example, in order to select the WCDMA signal from the multiple standard specification signals mixed in the received signals, the digital signal processor 253 provides the mode switch 213, the first duplexer 215, the second duplexer 217 and the filter 219, with a mode selection signal for selecting the WCDMA signal. In generating the mode selection signal, it is possible to either select a standard specification preset by the user or adaptively select a specific standard specification according to external signal conditions.

The mode switch 213 then switches the corresponding standard specification signal according to the mode selection signal. If the corresponding standard specification signal is a WCDMA signal, the mode switch 213 switches the signal to the first duplexer 215. If the corresponding standard specification signal is a CDMA2000 signal, the mode switch 213 switches the signal to the second duplexer 217. If the corresponding standard specification signal is a TD-SCDMA signal, the mode switch 213 switches the signal to the filter 219. If the RF signal received through the antenna 211 is a TD-SCDMA RF signal, the mode switch 213 provides time division duplexing (TDD).

The first duplexer 215, the second duplexer 217 or the filter 219 receive the signal output from the mode switch 213, and cancel unnecessary out-of-band signals, i.e., interference signals from the output signal of the mode switch 213, under the control of the digital signal processor 253. The first duplexer 215 duplexes the WCDMA signal to cancel interference components, if the RF signal selected by the mode switch 213 is a WCDMA signal. The second duplexer 217 duplexes the CDMA2000 signal to cancel interference components, if the RF signal selected by the mode switch 213 is a CDMA2000 signal. The filter 219 filters the TD-SCDMA signal to cancel interference components, if the RF signal selected by the mode switch 213 is a TD-SCDMA signal.

The interference-canceled signals output from either the first duplexer 215, the second duplexer 217 or the filter 219 are provided to the first low-noise amplifier 221, the second low-noise amplifier 223 or the third low-noise amplifier 225, respectively. The first low-noise amplifier 221, the second low-noise amplifier 223 and the third low-noise amplifier 225 are turned ON/OFF depending on a standard specification indicated by the mode selection signal from the digital signal processor 253. That is, one of the first low-noise amplifier 221, the second low-noise amplifier 223 and the third low-noise amplifier 225 is turned ON by the mode selection signal from the digital signal processor 253. For example, when the first low-noise amplifier 221 is selected, it low-noise-amplifies the output signal of the first duplexer 215 at a preset gain. Although the description has been made with reference to an example where the first low-noise amplifier 221 is turned ON for the sake of convenience, the operation will be performed in the same manner even when the second low-noise amplifier 223 and the third low-noise amplifier 225 are turned ON.

The output signal of the first low-noise amplifier 221 is provided in common to the first mixer 227 for an I component signal and the second mixer 229 for a Q component signal.

First, a procedure for processing the I component signal from the first low-noise amplifier 221 will be described. The first mixer 227 multiplies the output signal of the first low-noise amplifier 221 by a synthetic frequency output from the frequency synthesizer 231, and provides its output signal to the first high-pass filter bank 233. The frequency synthesizer 231 frequency-synthesizes an output signal of the digital signal processor 253 with an output signal of the programmable divider 251, to output the synthetic frequency. That is, the first mixer 227 performs frequency down-conversion by multiplying the I component signal output from the first low-noise amplifier 221 by the output signal of the frequency synthesizer 231, and provides its output signal to the first high-pass filter bank 233.

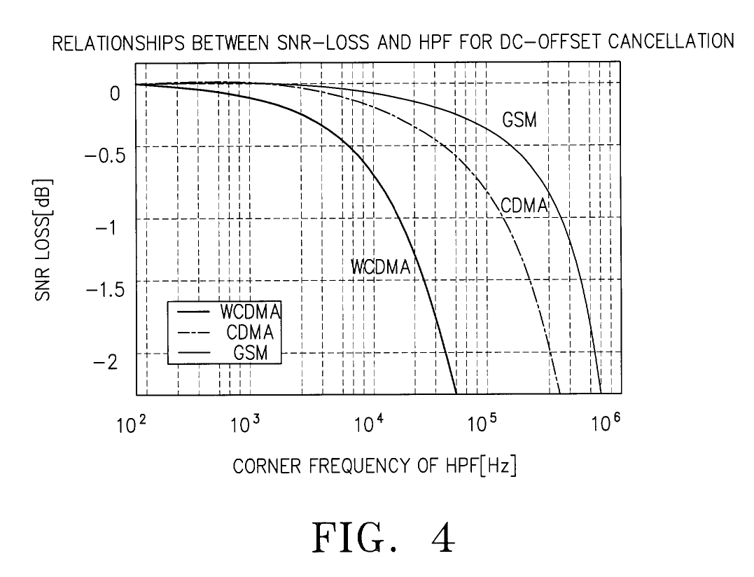

The first high-pass filter bank 233 then high-pass filters a baseband signal output from the first mixer 227, and provides its output signal to the first anti-aliasing filter 237. The reason for high-pass filtering the baseband signal output from the first mixer 227 is because the receiver fundamentally has a direction conversion receiver structure. That is, generally, the most significant shortcoming of the direct conversion receiver is that a signal-to-noise ratio (SNR) of a desired signal is degraded due to a DC offset, resulting in a reduction in the overall sensitivity of the direct conversion receiver. Therefore, in order to cancel the DC offset, the embodiment of the present invention uses the high-pass filter, and the high-pass filter is comprised of registers and capacitors, both being passive elements. Further, the reason that it is possible to use the high-pass filters is because the multiple standard specification RF signals are wideband signals rather than narrowband signals. A relationship between the high-pass filters and the signal-to-noise ratio is illustrated in FIG. 4. A detailed description of this will be made later. In addition, the high-pass filter bank is comprised of a plurality of high-pass filters in order to support the multiple standard specifications.

The output signal of the first high-pass filter bank 233 is provided to the first anti-aliasing filter 237, and the first anti-aliasing filter 237 removes an aliasing component from the output signal of the first high-pass filter bank 233 and provides its output signal to the first programmable Σ-∇ analog-to-digital converter 241. The first programmable Σ-∇ analog-to-digital converter 241 converts an analog signal output from the first anti-aliasing filter 237 into a digital signal, and provides its output signal to the first digital filter 245. The first programmable Σ-∇ analog-to-digital converter 241 passes desired signals and transforms undesired quantization noises and interference signals to a high frequency band, making it possible to acquire a desired signal-to-noise ratio at around a baseband frequency where the desired signals exist.

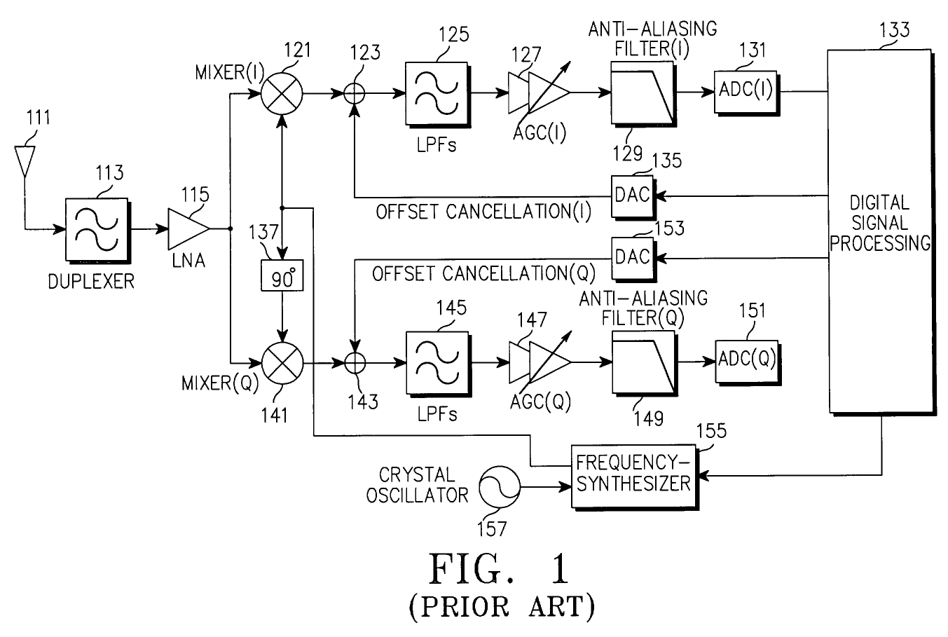

By comparison, the conventional direct conversion receiver of FIG. 1 uses the low-pass filters (LPF) and the automatic gain controllers (AGC) in the baseband stage for channel selection, whereas the direct conversion receiver according to an embodiment of the present invention uses the programmable Σ-∇ analog-to-digital converter which are not saturated by the strong-interference component and have a high signal-to-noise ratio to restore desired signals. In order to reduce a size of the first digital filter 245 arranged in the stage following the first programmable Σ-∇ analog-to-digital converter 241, the programmable divider 251 controls a sampling frequency of the Σ-∇ analog-to-digital converter to satisfy the particular bandwidth and required signal-to-noise ratio of the particular standard specification of the multiple standard specifications.

The programmable divider 251, under the control of the digital signal processor 253, outputs sampling frequencies corresponding to the pertinent one of the multiple standard specifications using the frequency oscillated by the crystal oscillator 249, and the programmable sampling frequency output from the programmable divider 251 is provided in common to the first programmable Σ-∇ analog-to-digital converter 241 and the second programmable Σ-∇ analog-to-digital converter 243, thus satisfying the bandwidth and required signal-to-noise ratio of the pertinent one of the multiple standard specifications.

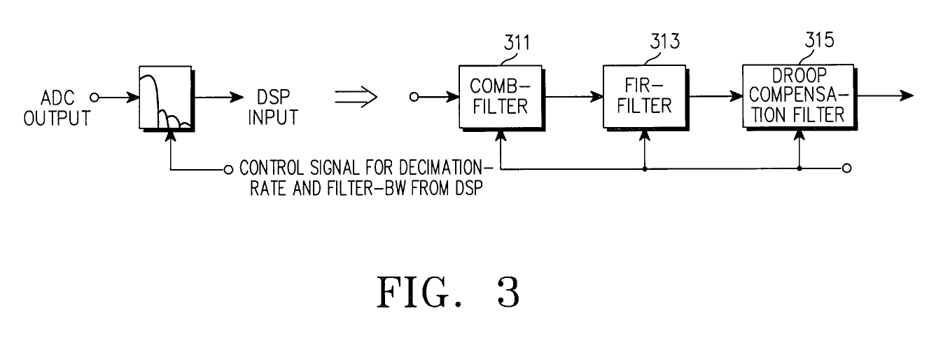

The first digital filter 245, under the control of the digital signal processor 253, digital-filters the digital signal output from the first programmable Σ-∇ analog-to-digital converter 241, and provides its output signal to the digital signal processor 253. A detailed description of the digital filtering process by the first digital filter 245 will be made later with reference to FIG. 3.

Heretofore, the description has been made of the procedure for processing the I component signal output from the first low-noise amplifier 221. Next, a description will be made of a procedure for processing the Q component signal output from the first low-noise amplifier 221.

The second mixer 229 multiplies the output signal of the first low-noise amplifier 221 by a signal obtained by phase shifting the synthetic frequency output from the frequency synthesizer 231 by 90°, and provides its output signal to the second high-pass filter bank 235. Here, the reason for phase shifting the output signal of the frequency synthesizer 231 by 90° in the second mixer 229 is to detect a Q component signal having a 90°-phase difference with the I component signal. The frequency synthesizer 231 frequency-synthesizes an output signal of the digital signal processor 253 with an output signal of the programmable divider 251, to output the synthetic frequency. That is, the second mixer 229 performs frequency down-conversion by multiplying the Q component signal output from the first low-noise amplifier 221 by the signal having a 90° phase difference with the output signal of the frequency synthesizer 231, and provides its output signal to the second high-pass filter bank 235.

The second high-pass filter bank 235 then high-pass-filters a baseband signal output from the second mixer 229, and provides its output signal to the second anti-aliasing filter 239. The reason for high-pass filtering the baseband signal output from the second mixer 229 is because the receiver fundamentally has a direction conversion receiver structure. That is, generally, the most significant shortcoming of the direct conversion receiver is that a signal-to-noise ratio (SNR) of a desired signal is degraded due to a DC offset, resulting in a reduction in the overall sensitivity of the direct conversion receiver. Therefore, in order to cancel the DC offset, the embodiment of the present invention uses the high-pass filter, and the high-pass filter is comprised of registers and capacitors, both being passive elements. Further, the reason that it is possible to use the high-pass filters is because the multiple standard specification RF signals are wideband signals rather than narrowband signals. A relationship between the high-pass filters and the signal-to-noise ratio is illustrated in FIG. 4. A detailed description of this will be made later. In addition, the high-pass filter bank is comprised of a plurality of high-pass filters in order to support the multiple standard specifications.

The output signal of the second high-pass filter bank 235 is provided to the second anti-aliasing filter 239, and the second anti-aliasing filter 239 removes an aliasing component from the output signal of the second high-pass filter bank 235 and provides its output signal to the second programmable Σ-∇ analog-to-digital converter 243. The second programmable Σ-∇ analog-to-digital converter 243 converts an analog signal output from the second anti-aliasing filter 239 into a digital signal, and provides its output signal to the second digital filter 247. The second programmable Σ-∇ analog-to-digital converter 243 passes desired signals and transforms undesired quantization noises and interference signals to a high frequency band, making it possible to acquire a desired signal-to-noise ratio at around a baseband frequency where the desired signals exist.

By comparison, the conventional direct conversion receiver of FIG. 1 uses the low-pass filters (LPF) and the automatic gain controllers (AGC) in the baseband stage for channel selection, whereas the direct conversion receiver according to an embodiment of the present invention uses the programmable Σ-∇ analog-to-digital converters which are not saturated by the strong-interference component and have a high signal-to-noise ratio to restore desired signals. In order to reduce a size of the second digital filter 247 arranged in the stage following the second programmable Σ-∇ analog-to-digital converter 243, the programmable divider 251 controls a sampling frequency of the Σ-∇ analog-to-digital converter thus satisfying the particular bandwidth and required signal-to-noise ratio of the particular standard specification of the multiple standard specifications.

The programmable divider 251, under the control of the digital signal processor 253, outputs sampling frequencies corresponding to the pertinent one of the multiple standard specifications using the frequency oscillated by the crystal oscillator 249, and the programmable sampling frequency output from the programmable divider 251 is provided in common to the first programmable Σ-∇ analog-to-digital converter 241 and the second programmable Σ-∇ analog-to-digital converter 243, thus satisfying bandwidth and required signal-to-noise ratio of the pertinent one of the multiple standard specifications.

The second digital filter 247, under the control of the digital signal processor 253, digital-filters the digital signal output from the second programmable Σ-∇ analog-to-digital converter 243, and provides its output signal to the digital signal processor 253. A detailed description of the digital filtering process by the second digital filter 247 will be made later with reference to FIG. 3.

A structure of the first digital filter 245 and the second digital filter 247 is now described in detail with reference to FIG. 3.

FIG. 3 illustrates an internal structure of the digital filters 245, 247 shown in FIG. 2. Referring to FIG. 3, the first digital filter 245 and the second digital filter 247 of FIG. 2 are each comprised of a comb filter 311, an FIR (Finite Impulse Response) filter 313 and a droop compensation filter 315. As illustrated in FIG. 3, the digital filters determine decimation rates and filter bandwidths corresponding to the pertinent one of the multiple standard specifications, under the control of the digital signal processor 253. The comb filter 311 acquires a decimation rate output from the digital signal processor 253, the FIR filter 313 performs channel selection, and the droop compensation filter 315 compensates for non-ideal effects.

Next, relationships between the signal-to-noise ratio and the high-pass filter banks 233, 235 of FIG. 2 is described with reference to FIG. 4.

FIG. 4 illustrates relationships between the signal-to-noise ratio and the high-pass filter bank of FIG. 2. In the embodiment of the present invention, the reason for using the high-pass filter banks, i.e., the first high-pass filter bank 233 and the second high-pass filter bank 235 is because the receiver of FIG. 2 according to the embodiment of the present invention fundamentally has a direct conversion receiver structure, i.e., because a signal-to-noise ratio of a desired signal is degraded due to a DC offset, resulting in a reduction in the overall sensitivity of the direct conversion receiver.

Specifically, FIG. 4 illustrates relationships between a signal-to-noise ratio loss and the corner frequency of the high-pass filter when DC-offset cancellation is performed on the respective standard specifications for the IMT-2000 mobile communication system. For example, in the case of the WCDMA standard specification and the currently commercialized CDMA or GSM standard specification, if a cut-off frequency of the high-pass filter is 1 KHz, there is almost no SNR loss.

Summarizing, the present invention provides a direct conversion receiver capable of supporting all of the standard specifications for the mobile communication system. That is, the direct conversion receiver is capable of supporting all of the standard specifications for the IMT-2000 mobile rd communication system, a 3^{rd} generation mobile communication system, for example, including the WCDMA standard specification, the CDMA2000 standard specification and the TD-SCDMA standard specification. Since a single direct conversion receiver can support all of the standard specifications for the mobile communication system, it is not necessary to develop separate receivers for the respective standard specifications, preventing a waste of unnecessary efforts.

Further, since a single direct conversion receiver can support all of the standard specifications for the mobile communication system, it is not necessary to provide separate receivers to the respective standard specifications, contributing to simplification of the hardware structure.

Finally, since a single direct conversion receiver can support all of the standard specifications for the mobile communication system, it is possible to increase utilization efficiency of resources, compared with when the separate receivers are provided for the respective standard specifications.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A direct conversion receiver capable of supporting multiple standard specifications in mobile communication systems, comprising:
a mode switch for selecting a received signal having a specific standard specification from received signals according to a mode selection signal;
a low-noise amplifier being turned on in response to the mode selection signal, for low-noise amplifying the received signal selected by the mode switch;
a frequency down-converter for frequency down-converting the low-noise amplified signal into a frequency corresponding to the specific standard specification;
a high-pass filter bank for high-pass filtering the frequency down-converted signal;
a programmable analog-to-digital converter for converting the high-pass filtered signal into a sampling frequency corresponding to the specific standard specification;
a digital filter for digital-filtering the converted digital signal using a decimation rate and a filter bandwidth corresponding to the specific standard specification; and
a digital signal processor for generating the mode selection signal for selecting a desired standard specification signal from the received signals, and generating a control signal for generating the sampling frequency.

2. The direct conversion receiver of claim 1, wherein the high-pass filter bank is comprised of a plurality of high-pass filters for the respective standard specifications.

3. The direct conversion receiver of claim 1, wherein the digital filter comprises:
a comb filter for acquiring a decimation rate of an input signal;
an FIR (Finite Impulse Response) filter for performing channel selection on the received signal; and
a droop compensation filter for compensating for non-ideal effects of the input signal.

4. The direct conversion receiver of claim 1, wherein the multiple standard specifications include a WCDMA (Wideband Code Division Multiple Access) standard specification, a CDMA2000 standard specification, and a TD-SCDMA (Time Division-Synchronous Code Division Multiple Access) standard specification.

5. The direct conversion receiver of claim 4, wherein the mode switch provides time division duplexing (TDD) when the specific standard specification is the TD-SCDMA standard specification.

6. The direct conversion receiver of claim 1, further comprising a duplexer for canceling an interference component from the output signal of the mode switch.

7. The direct conversion receiver of claim 1, further comprising a filter for canceling an interference component from the output signal of the mode switch.

8. The direct conversion receiver of claim 1, further comprising a programmable divider for generating a sampling frequency for the specific standard specification for the programmable analog-to-digital converter according to the mode selection signal from the digital signal processor.

9. A direct conversion receiver capable of supporting multiple standard specifications in a mobile communication system, comprising:
an RF (Radio Frequency) front-end part for selecting a received signal having a specific standard specification from received signals according to a mode selection signal, and low-noise amplifying the selected received signal;
a frequency down-conversion part for frequency down-converting the low-noise amplified signal to a frequency corresponding to the specific standard specification; and
a baseband part for high-pass filtering the frequency down-converted signal, and converting the high-pass filtered signal to a sampling frequency corresponding to the specific standard specification.

10. The direct conversion receiver of claim 9, wherein the RF front-end part comprises:
a mode switch for selecting a received signal having a specific standard specification from the received signals according to the mode selection signal; and
a low-noise amplifier being turned on in response to the mode selection signal, for low-noise amplifying the received signal selected by the mode switch.

11. The direct conversion receiver of claim 9, wherein the frequency down-conversion part comprises:
a frequency synthesizer for generating a frequency corresponding to the specific standard specification; and
a down-converter for multiplying the frequency generated by the frequency synthesizer by the low-noise amplified signal.

12. The direct conversion receiver of claim 9, wherein the baseband part comprises:
a high-pass filter bank for high-pass filtering the frequency down-converted signal;
a programmable analog-to-digital converter for converting the high-pass filtered signal to a sampling frequency corresponding to the specific standard specification;
a digital filter for digital filtering the converted digital signal using a decimation rate and a filter bandwidth corresponding to the specific standard specification; and
a digital signal processor for generating the mode selection signal for selecting a desired standard specification signal from the received signals, and generating a control signal for generating the sampling frequency.

13. The direct conversion receiver of claim 12, wherein the high-pass filter bank is comprised of a plurality of high-pass filters each corresponding to one of the respective standard specifications.

14. The direct conversion receiver of claim 12, wherein the digital filter comprises:
a comb filter for acquiring a decimation rate of an input signal;
an FIR (Finite Impulse Response) filter for performing channel selection on the input signal; and
a droop compensation filter for compensating for non-ideal effects of the input signal.

15. The direct conversion receiver of claim 10, wherein the multiple standard specifications include a WCDMA (Wideband Code Division Multiple Access) standard specification, a CDMA2000 standard specification, and a TD-SCDMA (Time Division-Synchronous Code Division Multiple Access) standard specification.

16. The direct conversion receiver of claim 15, wherein the mode switch provides time division duplexing (TDD) when the specific standard specification is the TD-SCDMA standard specification.

17. The direct conversion receiver of claim 10, further comprising a duplexer for canceling an interference component from the output signal of the mode switch.

18. The direct conversion receiver of claim 10, further comprising a filter for canceling an interference component from the output signal of the mode switch.

19. The direct conversion receiver of claim 12, further comprising a programmable divider for generating a sampling frequency of the specific standard specification for the programmable analog-to-digital converter according to the mode selection signal from the digital signal processor.
